(19) United States
(12) Patent Application Publication
(10) Pub. No.: US 2007/0176157 A1
(43) Pub. Date: Aug. 2, 2007

(54) Materials handling technology

(76) Inventors: David W. Lutz, Cohasset, MN (US); Jeff Miels, Grand Rapids, MN (US)

Correspondence Address: JOEL D. SKINNER, JR.;SKINNER AND ASSOCIATES, 212 COMMERCIAL ST., HUDSON, WI, 54016, US

(21) Appl. No.: 11/343,556

(22) Filed: Jan. 31, 2006

(51) Int. Cl. B66F 3/00

(52) U.S. Cl. 254/120

(57) ABSTRACT

A tool for attachment to a foot or shoe of a user for levering a workpiece, such as a sheet of wall board. The tool has a body having a first portion for positioning under a forward part of the sole of a user's foot, and a second portion connected to the first portion and extending forwardly therefrom. The second portion is angled upwardly with respect to the first portion. A top strap is connected to the body; and a heel strap is also connected to the body. Also disclosed is a method of using the tool by placing the tool on the foot of a user and engaging a portion of the second portion under a workpiece by laying the second portion substantially flat on an environmental surface below the workpiece. In this position, the first portion is elevated above the surface at an angle. The first portion is then forced downward with the foot, so that the second portion moves upwardly and levers the workpiece

### REFERENCE TO A MICROFICHE APPENDIX, IF ANY

Not applicable.

### BACKGROUND

1. Field

The present invention relates, generally, to materials handling technology. More particularly, the invention relates to a tool for manipulating material, particularly sheet-like building material such as gypsum board, plywood and the like. The invention also relates to a method of using the tool.

2. Background Information

Existing material lifting and manipulating technology, in general, includes crow bars, wonder bars, hammers and the like, and methods of using such devices.

This technology is believed to have significant limitations and shortcomings, including but not limited to that they require the user to manipulate the tool by hand, they often require the user to kneel or bend over during use, and other lifting limitations.

For these and other reasons, a need exists for the present invention.

### BRIEF SUMMARY

The present invention provides a levering and lifting tool apparatus and method which is practical, reliable, accurate and efficient, and which is believed to fulfill a need and to constitute an improvement over the background technology.

The lifting tool apparatus and method of the present invention harnesses the power of the human foot for lifting. The human foot is mechanical complex and structurally strong mechanism. The ankle serves as foundation, shock absorber, and propulsion engine for the body. The foot can sustain enormous pressure (several tons over the course of a one-mile run) and provides flexibility and resiliency. Structurally, the foot has three main parts: the forefoot, the midfoot, and the hindfoot. The forefoot is composed of the five toes (phalanges) and their connecting long bones (metatarsals). Each toe (phalanx) is made up of several small bones. The big toe (hallux) has two phalanges, two joints (interphalangeal joints), and two tiny, round sesamoid bones that enable it to move up and down. The other four toes each have three bones and two joints. The phalanges are connected to the metatarsals by five metatarsal phalangeal joints at the ball of the foot. The forefoot bears half the body's weight and balances pressure on the ball of the foot. The midfoot has five irregularly shaped tarsal bones, forms the foot's arch, and serves as a shock absorber. The bones of the midfoot are connected to the forefoot and the hindfoot by muscles and the plantar fascia (arch ligament). The hindfoot is composed of three joints and links the midfoot to the ankle (talus). The top of the talus is connected to the two long bones of the lower leg (tibia and fibula), forming a hinge that allows the foot to move up and down. The heel bone (calcaneus) is the largest bone in the foot. It joins the talus to form the subtalar joint, which enables the foot to rotate at the ankle. The bottom of the heel bone is cushioned by a layer of fat.

The sole is the bottom of the foot. The instep is the top of the foot. The ball of the foot is where the toes join to the rest of the foot. It is quite muscular. The arch of the foot is the area of the bottom of the foot between the heel pad and toe pad. The heel is the prominence at the posterior end of the foot. It is based on the projection of one bone, the calcaneus, behind the articulation of the bones of the lower leg

In one aspect, the invention provides a tool for attachment to a foot or shoe of a user for levering a workpiece, comprising a body having a first portion adapted to positioned under a forward part of the sole of a user's foot, and a second portion connected to the first portion and extending forwardly therefrom, the second portion being angled upwardly with respect to the first portion; a top strap connected to the body; and a heel strap communicatively connected to the body.

In another, more particular, aspect the invention provides a tool for attachment to a foot or shoe of a user for levering a workpiece, comprising:
a. a body having a substantially planar front portion adapted to positioned under a forward part of the sole of a user's foot, the front portion having a wide front edge with ears, and a rear portion connected to the front portion and extending rearwardly therefrom, the front portion being angled upwardly with respect to the rear portion and having a flat bottom, the body further having a pair of slots disposed adjacent the sides of the center portion and a recess is disposed in a bottom of the body surrounding each slot;
b. a top strap connected to the body and transversely oriented thereto, the top strap including a predetermined length of strap material looped through the slots so that it overlays the top of the body, a male buckle adjustably connected adjacent one end of the strap material, and a complementary female buckle adjustably connected adjacent the opposite end of the strap material; and

a heel strap communicatively connected to the body and extending behind the rear portion, the heel strap including a predetermined length of strap material, and a snap connected adjacent each end thereof, the snaps being communicatively connected to the top strap. In yet another aspect, the invention provides a method of levering a workpiece, comprising the steps of:
a. providing a tool comprising:
   i. a body having a first or rear portion adapted to positioned under a forward part of the sole of a user's foot, and a second or front portion connected to the first portion and extending forwardly therefrom, the front portion being angled upwardly with respect to the rear portion;
   ii. a top strap connected to the body; and
   iii. a heel strap communicatively connected to the body.
b. placing the tool on the foot of a user;
c. engaging a portion of the first portion under a workpiece by laying the first portion substantially flat on an environmental surface below the workpiece whereby the second portion is elevated above the surface at an angle; and
d. forcing the second portion downward with the foot, whereby the first portion moves upwardly and levers the workpiece.

The features, advantages, benefits and objects of the invention will become clear to those skilled in the art by reference to the following description, claims and drawings.

### BRIEF DESCRIPTION OF THE SEVERAL VIEWS OF THE DRAWING

FIG. 1 is a perspective view of an embodiment of the tool of the present invention.

FIG. 2 is a top view of the tool.

FIG. 3 is a side view of the tool operatively disposed on the foot of a user.

FIG. 4 is a view of the operatively disposed tool engaging a work piece.

FIG. 5 is a top view of an embodiment of a body of the tool.

FIG. 6 is a perspective view of an alternative embodiment of the body of the tool.

FIG. 7 is a perspective view of the body showing the bottom thereof.

FIG. 8 is a top view of the body.

FIG. 9 is a bottom view of the body.

FIG. 10 is a front end view of the body.

FIG. 11 is an opposite, back end view of the body.

FIG. 12 is a side view of the body.

FIG. 13 is a crossectional view of the body taken along line 13-13 of FIG. 8.

FIG. 14 is a crossectional view of the body taken along line 13-13 of FIG. 8.

FIG. 15 is a crossectional view of the body taken along line 15-15 of FIG. 8.

FIG. 16 is a bottom view of an embodiment of the body showing a traction pad.

FIG. 17 is a perspective view of another embodiment of the device.

FIG. 18 is a top view of the device of FIG. 17.

FIG. 19 is a perspective view of the device of FIG. 17 in an operative configuration.

FIG. 20 is a perspective view of an insert member disposed on a body.

FIG. 21 is a front view of an embodiment of the device including the insert.

### DETAILED DESCRIPTION

The embodiments of the invention described is intended to be illustrative and not to be exhaustive or limit the invention to the exact forms disclosed. The embodiments are chosen and described so that persons skilled in the art will be able to understand the invention and the manner and process of making and using it.

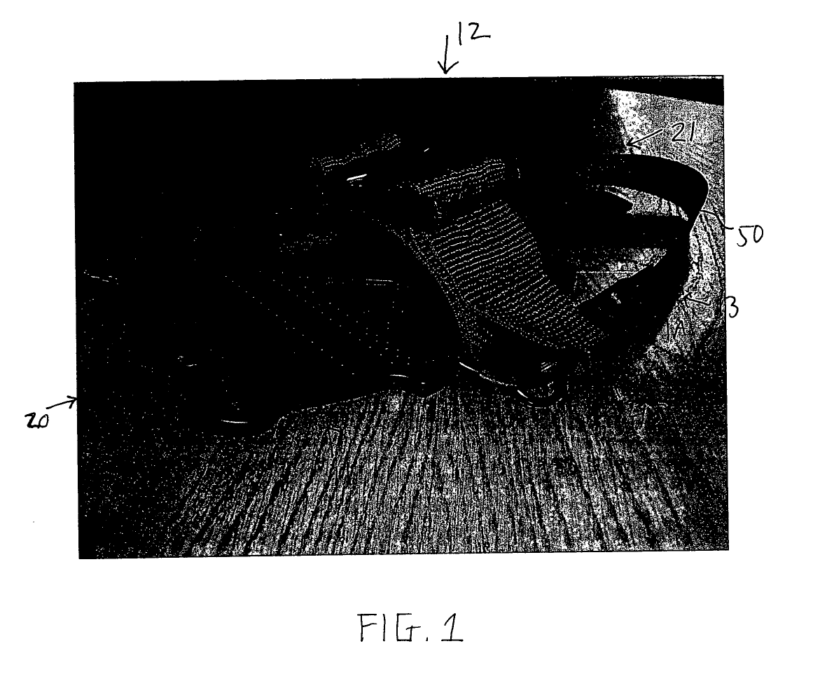

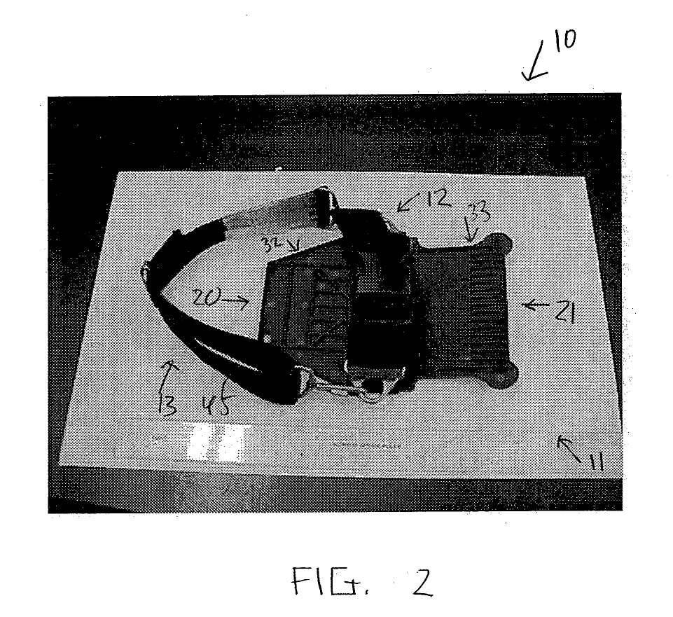

FIGS. 1 and 2 show an embodiment of the lifting tool 10 of the present invention comprising generally, a body 11, a top or instep strap 12 connected to the body 10, and a rear or heel strap 13 connected to the top strap 12 and body.

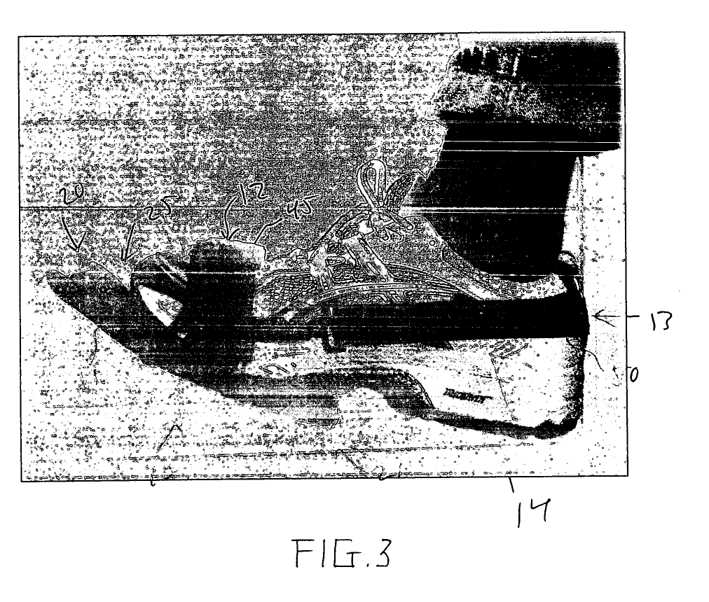

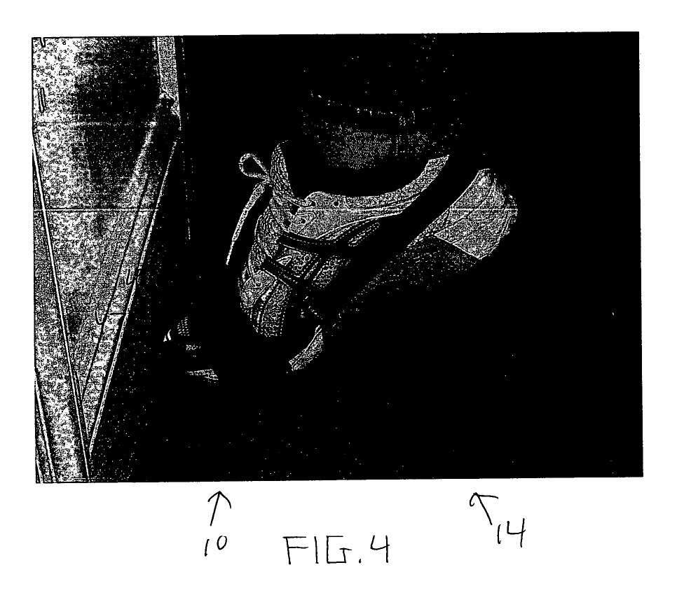

Referring also to FIGS. 3 and 4, in a preferred usage, the tool 10 is secured to a shoe 14 or foot of a user. A pair of tools 10 may be applied to the right and left feet simultaneously of a user. Operatively secured, the user may walk or otherwise move about. The user positions his or her foot and the attached lifting tool 10 near a piece of material 15 or other work piece, for example a standard sheet or panel of drywall construction material, plywood, lumber, glass, plastic, or the like. The user moves his foot 14 so that the front edge of the tool 10 is disposed under and edge of the workpiece 15 which is also resting on the ground. In this position the user's toe is pointed downwardly, also resting on the ground, and his heel is raised slightly above the ground. Keeping the toe on the ground, the user next pushes his heel towards the ground. Due to the configuration of the tool 10, this causes the toe, and front end of the tool 10, to automatically rise. The rising front end of the tool 10 lifts the workpiece 15 off of the ground. The user can easily, securely and comfortably maintain this position for a relatively long period of time. Additionally, both of the user's hands are free during this activity to manipulate the workpiece 15, to hold and use other tools, and for other purposes.

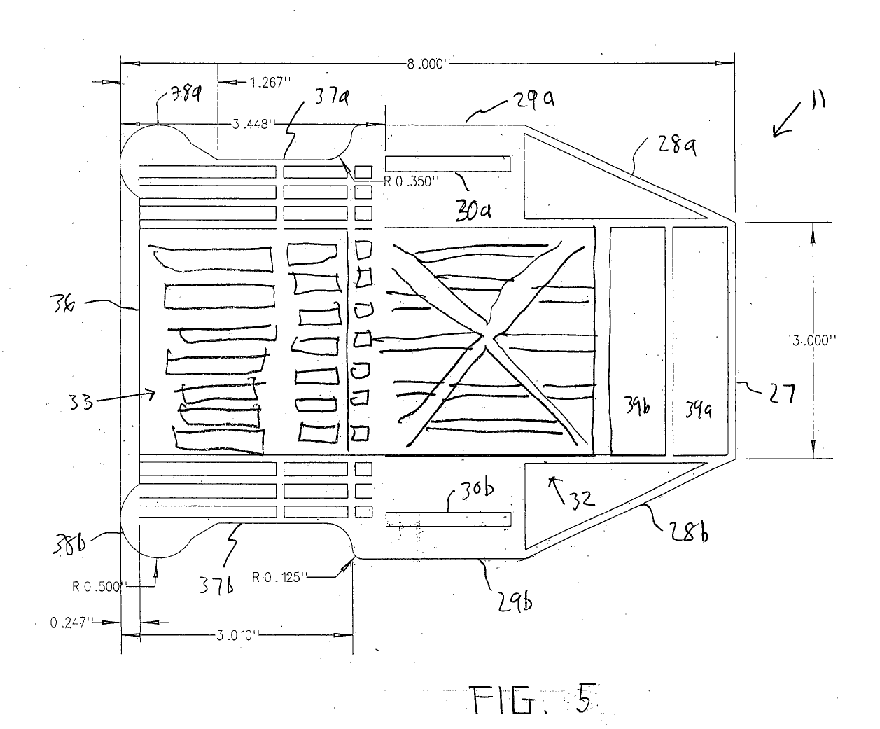

FIG. 5 is a top view of an embodiment of the body 11 used with the tool 10 of FIGS. 1 and 2, and showing a first (rear or back) portion 20 and a second (front or forward) portion 21. The body 11 is constructed of a strong, lightweight and rigid material, preferably a polymeric material. It is preferably approximately 8 inches (20.5 cm) long and between 3 inches (7.5 cm.) wide at the front, thinnest aspect and 5.5 inches (14 cm.)wide at its widest aspect. The body 11 is preferably approximately 0.25 inches (7 mm.) thick. However, areas which are ribbed may be thinner between the ribs, for example approximately 0.125 inches (3.5 mm.) thick. This reduces weight while retaining rigidity and strength.

Its perimeter is defined by a back edge 27, sloping side edges 28 a and b, center side edges 29a and b, inset side edges 37a and b, front corner lobed portions 38 a and b, and front edge 36. The front edge 36 is straight and has a length of about 5 inches for engaging a workpiece. Strap slots 30 a and b are disposed adjacent the center side edges 29 for receiving loops of the top strap 12.

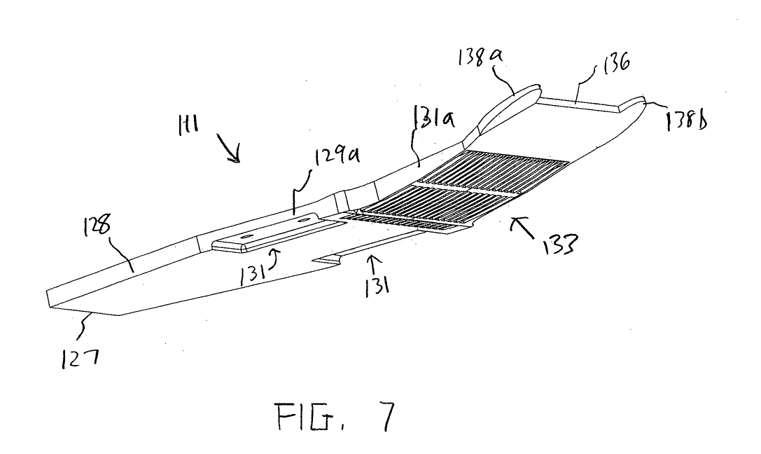

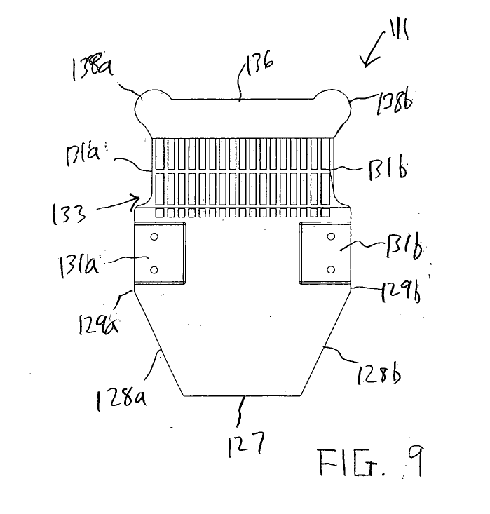

The top of the body 11 has a central ribbed region 32 of a predetermined area sufficient to support the ball of a user's foot or shoe. A plurality of ribs 33 preferably extend forwardly from the central region 32. A pair of recessed areas 39a and b are disposed rearward of the central region 32. These features are preferably molded into the body 11. The bottom of the body 11 is shown to have a substantially smooth flat surface. Recesses (not shown) preferably surround the strap slots 30. The recesses are substantially similar to recesses 131 shown in FIGS. 7 and 9 for example.

A preferred embodiment of the top strap 12 preferably comprises a predetermined length of strap material 45 which is configured such that it lays over center region 32 and each of its ends is disposed downwardly through a slot 30 and looped upwardly around the side. A male buckle 46 is adjustably connected to one end of the strap 45 and a complementary female buckle 47 is adjustably connected to the opposite end of the strap 45. The buckles may be plastic or metal. Exemplary strap material is 1.5 inch (4 cm.) wide polymeric webbing.

A preferred embodiment of the heel strap 13 preferably comprises a predetermined length of strap material 50 (for example 1.0 inch wide). Each end of the strap 50 has a snap 51a and b connected to it. One snap 51a is preferably fixedly connected by a sewn connection. The other snap 51b is preferably adjustably connected by a looped connection. The free end of the strap 50 is preferably held in place via a standard adjustable buckle 53. The buckles and snaps may be plastic or metal.

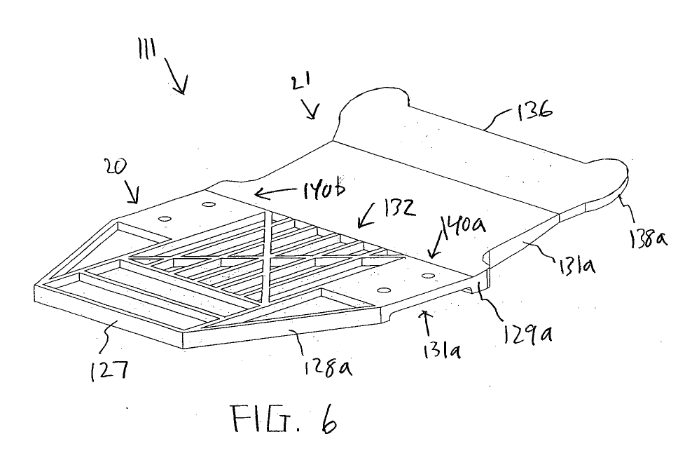

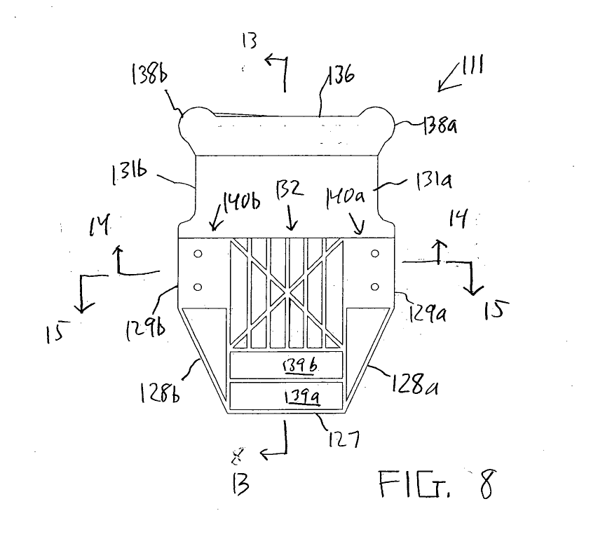

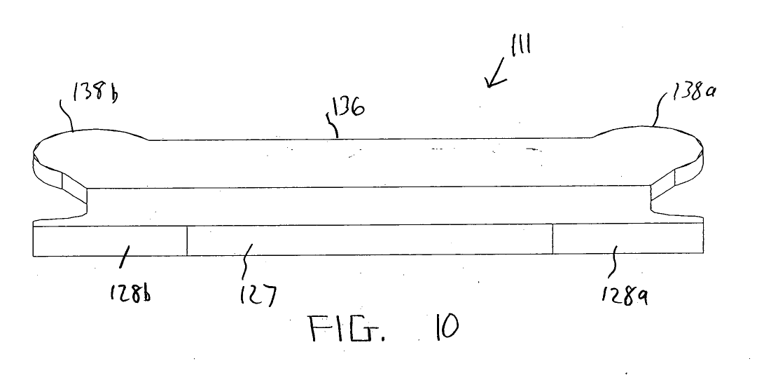

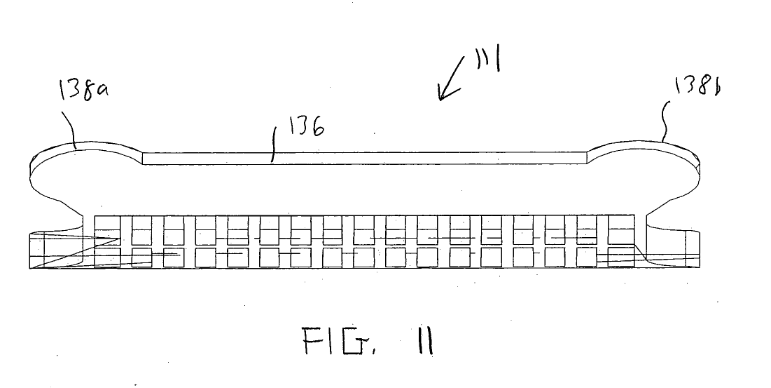

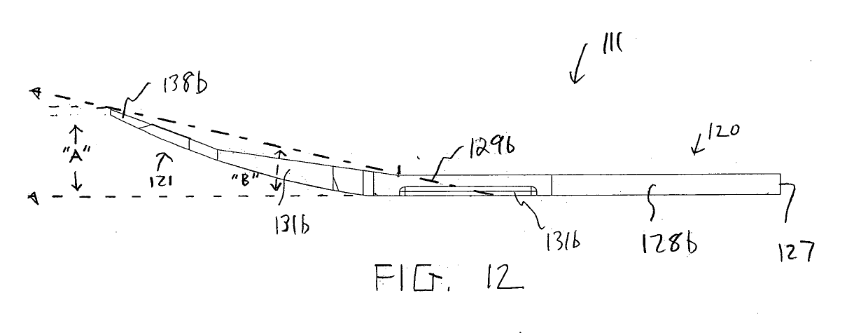

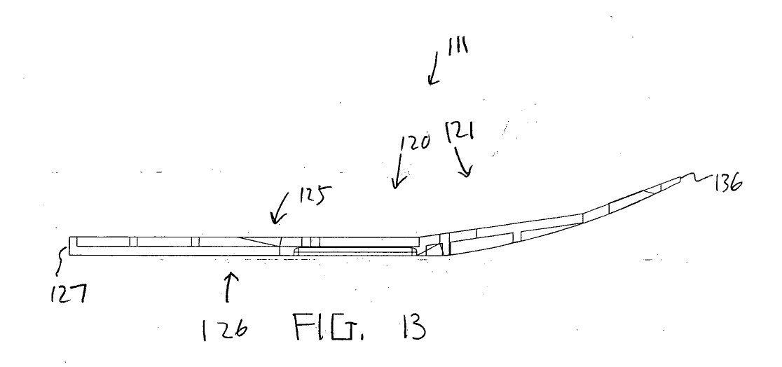

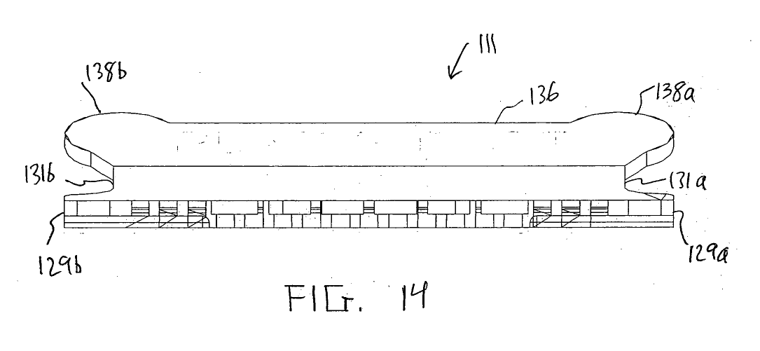

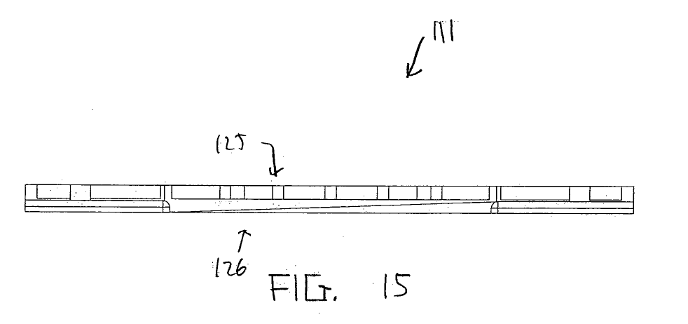

FIGS. 6-15 show an alternative embodiment of the body 111 used with the tool of FIGS. 1 and 2, and having a planar rear portion 120 and a substantially planar but slightly curved or rockered front portion 121, which is angled upwardly, with respect to the front portion. As is best shown in FIG. 12, the angled (“B” of approximately 13 degrees) connection creates a gap “A” of approximately 0.75 inches (2 cm.) between the top of the front portion 121 and the ground. This dimension is the lifting distance of the tool 10. The body 111 is also constructed of a strong, lightweight and rigid material, preferably a polymeric material. Its perimeter is defined by a rear edge 127, sloping side edges 128a and b, center side edges 129a and b, inset side edges 137a and b, front corner lobed portions or ears 138a and b, and front edge 136. It's dimensions are substantially the same as embodiment 11 discussed above. Strap aperture pairs 130a and b are disposed adjacent the center side edges 129 for receiving connectors of the top strap 12.

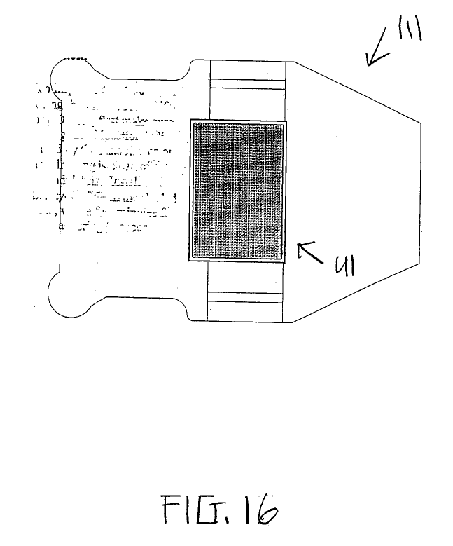

The top of the body 111 has a central ribbed region 132. A plurality of ribs 133 extend forwardly on the bottom of the body 111. A pair of recessed areas 139 are disposed rearward of the central region 132. The bottom of the body 111 preferably has a substantially smooth flat surface. Alternatively, a piece of grip material may be placed on the bottom as shown in FIG. 16. Recesses 131 preferably surround the strap slots 30.

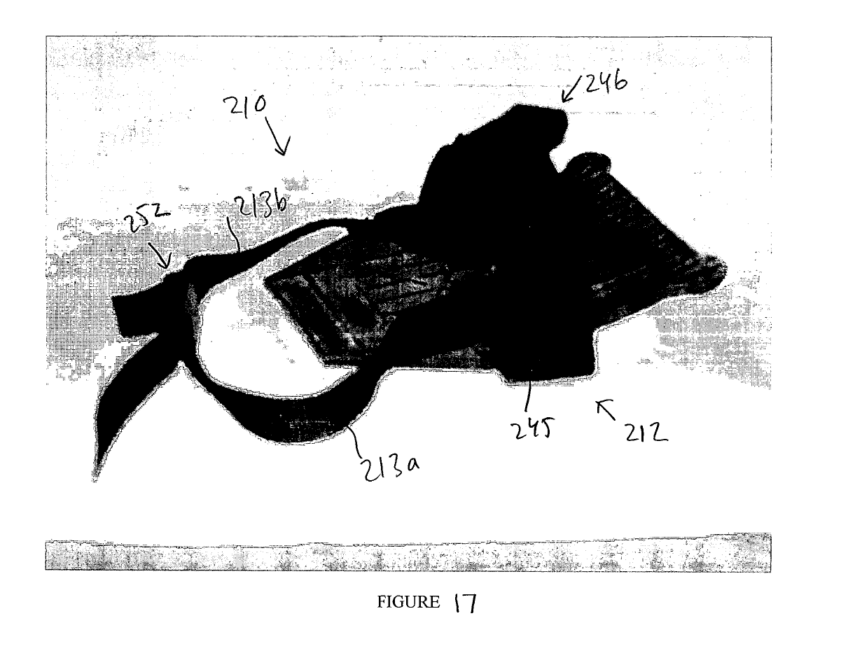

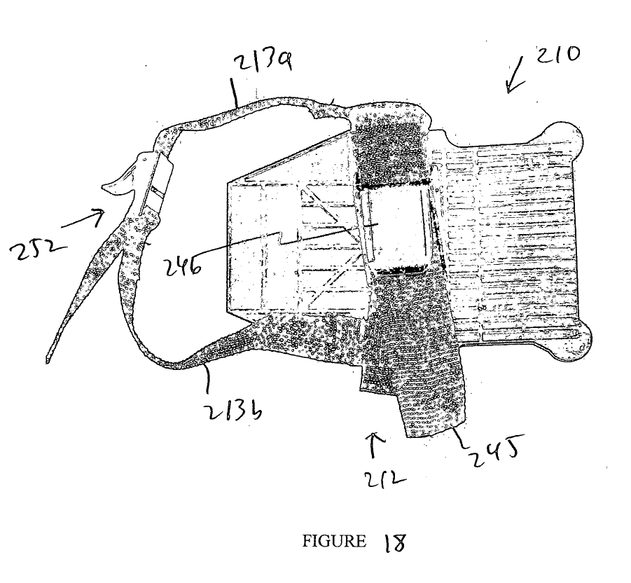

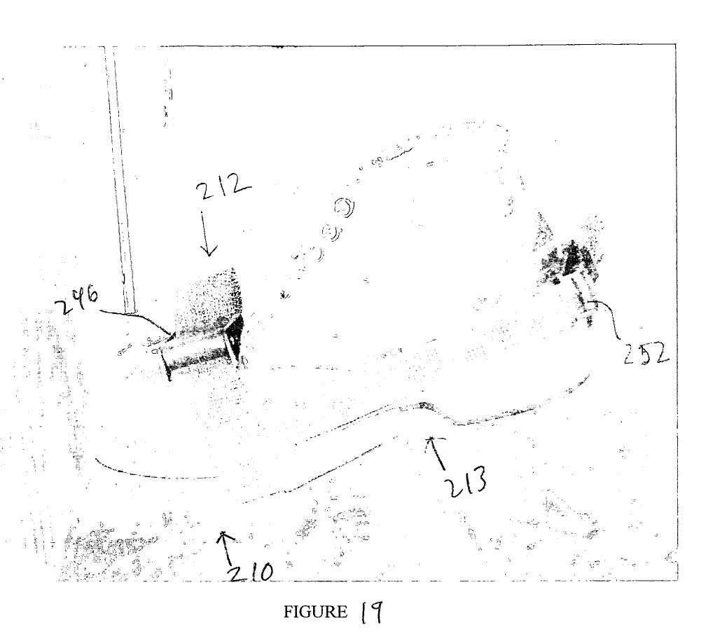

FIGS. 17-19 show a further alternative embodiment of the device 210 with top strap 212 comprising a predetermined length of 245 strap material which is configured such that it lays over center region and each of its ends is disposed downwardly through a body slot and looped upwardly around the side. A clamping buckle 246 is fixedly connected to one end of the strap 245 and the opposite end of the strap 245 is slid (placed) through the buckle 246 where clamping is accomplished. The buckle 246 may be plastic or metal. The heel strap preferably comprises a pair of strap member 213a and b. Each end of the strap 213 has a sewn loop on one end. One strap 213a is fixedly connected to a clamping buckle 252. The other strap 213b is adjusted by sliding the end through buckle 252 to form a clamped connection. The sewn loop ends of straps 213a and b are held in place around the strap 245.

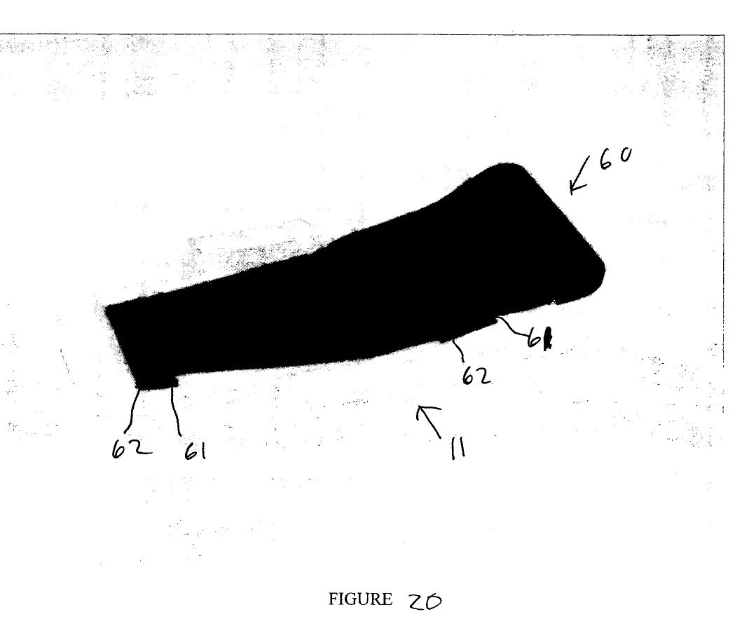

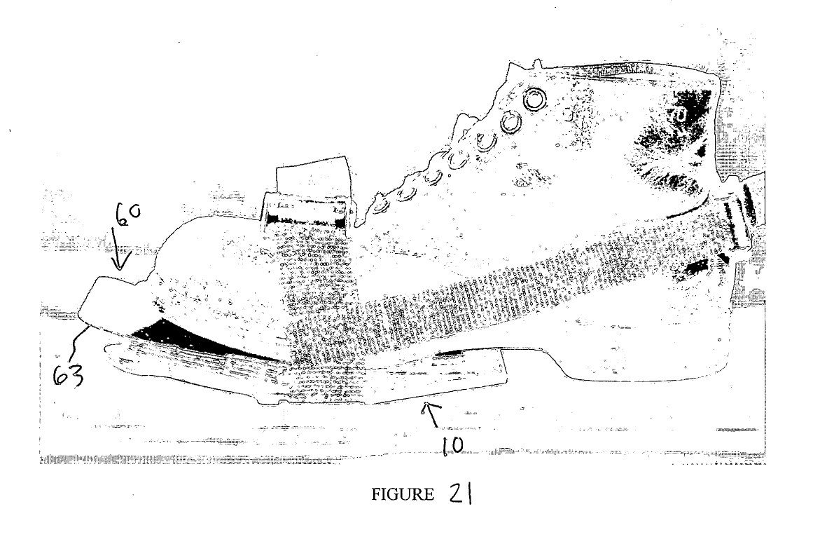

FIGS. 20 and 21 show an optional metal insert 60 connected to a body 11. The insert 60 is intended to increase the lifting capacity of the device. The insert 60 has a predetermined shape and configuration for mating with the body 11, whereby a forward end 63 extends a predetermined distance beyond the front end 21 of the body 11. Preferably, the insert 60 has a plurality of tabs 61 which mate with slots 62 in the body 11. The insert 60 is preferably constructed of steel.

Referring again to FIGS. 1-4, in use, the tool 10 is secured to a shoe 14. With the heel strap 13 connected to the body 11 at both ends 51a and b, and the top strap 12 buckle 46 and 47 disconnected, the forward part of the sole or bottom of the user's foot, preferably the ball of the foot (in shoe 14), is positioned over the center region 32/132 so that it is forward of the junction between the connection of the forward 21 and rearward 20 portions. In this position, the back edge 20 of the body 11 is positioned rearwardly on the foot, preferably aligned somewhere along the arch or heel of the user depending upon foot/shoe size. The user then connects buckles 46 and 47, and adjusts the top strap 12 with respect to the instep so that the body 11 is snugly attached to the bottom of the shoe 14. This also closely holds the heel strap 13 behind the heel of the user. Thus, the top strap 12 substantially holds the tool 11 vertically (i.e. from sole to instep) in place with respect to the bottom of the shoe 14, while the heel strap 13 holds the tool 11 horizontally and longitudinally (i.e. from toe to heel) with respect to the foot. The user is free to move about substantially normally. When lifting is desired, the user positions his or her foot and the attached lifting tool 10 near a workpiece 15. The user moves his foot 14 so that the front edge of the tool 10 is disposed under and edge of the workpiece 15 which is also resting on the ground. In this position the user's toe is pointed downwardly or flat, also resting on the ground, and his heel is raised slightly above the ground. Keeping the toe on the ground, the user next pushes his heel towards the ground. Due to the configuration of the tool 10, this causes the toe, and front end of the tool 10, to automatically rise. The rising front end of the tool 10 wedges or levers and lifts the workpiece 15 off of the ground. Movement of the foot can adjust the degree of forcefulness of the lift and the amount of lift.

Although the apparatus and method has been described in connection with the field of wall board handling, it can readily be appreciated that it is not limited solely to such field, and can be used in other fields.

The descriptions above and the accompanying drawings should be interpreted in the illustrative and not the limited sense. While the invention has been disclosed in connection with an embodiment or embodiments thereof, it should be understood by those skilled in the art that there may be other embodiments which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

1. A tool for attachment to a foot or shoe of a user for levering a workpiece, comprising:
a. a body having a first portion adapted to positioned under a forward part of the sole of a user's foot, and a second portion connected to the first portion and extending forwardly therefrom, the second portion being angled upwardly with respect to the first portion; and
b. a strap connected to the body.

2. The tool of claim 1, wherein the first portion is a rear portion and the second portion is a front portion.

3. The tool of claim 1, wherein the body first portion is substantially planar.

4. The tool of claim 3, wherein the body first portion has a wide front edge of a predetermined length and a pair of corner ears adapted for engaging the workpiece.

5. The tool of claim 4, wherein the body first portion has side edges which taper towards a back edge.

6. The tool of claim 1, wherein the body second portion is slightly outwardly curved on its bottom.

7. The tool of claim 1, wherein the body first portion has at least one strap connector disposed on each side for transverse alignment of the strap across the first portion.

8. The tool of claim 7, wherein the strap connector is a slot adapted for looping the strap through it.

9. The tool of claim 8, wherein a recess is disposed in a bottom of the body surrounding the slot for nesting the strap with respect to the bottom.

10. The tool of claim 7, wherein the strap connector is at least one aperture for securing strap connector hardware therethrough.

11. The tool of claim 3, wherein the second portion is angled upwardly at an angle of approximately 13 degrees.

12. The tool of claim 11, wherein the front portion has a length of approximately 5 inches and the rear portion has a length of approximately 3 inches, whereby a front edge of the front portion is offset approximately 0.75 inches from the plane of the rear portion.

13. The tool of claim 1, wherein at least a portion of the body is has an interiorly disposed ribbed structure.

14. The tool of claim 2, wherein the body has a front to back longitudinal axis, and wherein the strap is disposed transversely thereto.

15. The tool of claim 21, wherein the top strap comprises a predetermined length of strap material looped through the slots so that it overlays the top of the body, a male buckle adjustably connected adjacent one end of the strap material, and a complementary female buckle adjustably connected adjacent the opposite end of the strap material.

16. The tool of claim 15, wherein the top strap is disposed over the body first portion adjacent the body second portion.

17. The tool of claim 21, wherein the heel strap comprises a predetermined length of strap material, and a snap connected adjacent each end thereof, the snaps being communicatively connected to the top strap.

18. The tool of claim 1, further comprising a nonslip body bottom surface.

19. A tool for attachment to a foot or shoe of a user for levering a workpiece, comprising:
a. a body having a substantially planar rear portion adapted to positioned under a forward part of the sole of a user's foot and a front portion connected to the rear portion and extending forwardly therefrom, the front portion being angled upwardly with respect to the rear portion and having a curved bottom, the front portion having a wide straight front edge with corner ears, the body further having a pair of slots disposed adjacent the sides of the front portion and a recess is disposed in a bottom of the body surrounding each slot;
b. a top strap connected to the body and transversely oriented thereto, the top strap including a predetermined length of strap material looped through the slots so that it overlays the top of the body, a male buckle adjustably connected adjacent one end of the strap material, and a complementary female buckle adjustably connected adjacent the opposite end of the strap material; and
c. a heel strap communicatively connected to the body and extending behind the rear portion, the heel strap including a predetermined length of strap material, and a snap connected adjacent each end thereof, the snaps being communicatively connected to the top strap.

20. A method of levering a workpiece, comprising the steps of:
a. providing a tool comprising:
i. a body having a first portion adapted to positioned under a forward part of the sole of a user's foot, and a second portion connected to the first portion and extending forwardly therefrom, the second portion being angled upwardly with respect to the first portion;
ii. a top strap connected to the body; and
iii. a heel strap communicatively connected to the body.
b. placing the tool on the foot of a user;
c. engaging a portion of the second portion under a workpiece by laying the second portion substantially flat on an environmental surface below the workpiece whereby the first portion is elevated above the surface at an angle; and
d. forcing the first portion downward with the foot, whereby the second portion moves upwardly and levers the workpiece.

21. The tool of claim 1, wherein the strap comprises,
a. a top strap connected to the body; and
b. a heel strap communicatively connected to the body.
